(19) United States
(12) Patent Application Publication
(10) Pub. No.: US 2005/0242239 A1
(43) Pub. Date: Nov. 3, 2005

(54) Method for VTOL aircraft landing with external load

(76) Inventor: Mark Winfield Scott, Bethany, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/837,736

(22) Filed: May 3, 2004

(51) Int. Cl. B64B 1/34

(52) U.S. Cl. 244/137.4

(57) ABSTRACT

A method for landing a VTOL aircraft includes winching down an external load under the force of gravity such that the external load is hung a predetermined distance below the VTOL aircraft and lands prior to the VTOL aircraft. In an autorotation situation, the VTOL aircraft is essentially performing a flair at an altitude which is equivalent to the predetermined distance such that the external load achieves a relatively soft landing suitable for a manned external load.

### BACKGROUND OF THE INVENTION

The present invention relates to a method for landing a VTOL aircraft that is carrying an external slung load, and more particularly to an autorotation landing.

Vertical takeoff and landing (VTOL) aircraft are unique in their ability to carry loads externally. Future military forces require enhanced vertical lift capabilities in a compact package. The CH-53E is currently the world's largest shipboard compatible helicopter. A significant consideration in the design of the CH-53E is shipboard compatibility. The CH-53E effectively defines the maximum aircraft spatial capacity which will fit on the elevators and in the hangar deck of United States Marine Corps Amphibious Assault Ships, more commonly called an LHA or LHD. Emerging payload weight requirements are beyond the growth capabilities of the CH-53E while maintaining current shipboard compatibility requirements. Thus, a conventional helicopter like the CH-53E would be so large that it would not fit in the hangar deck or on the elevator of an LHA or LHD.

Super heavy lift (SHL) VTOL aircraft are generally defined as an aircraft with twice the largest payload carried by current conventional helicopters. Future requirements are envisioned to be in the range of approximately 70,000 pounds of payload over a 400 mile range while being shipboard compatible.

A dedicated external load configuration SHL VTOL aircraft has potential to meet the desired shipboard requirements. This configuration provides the potential to carry manned external loads, such as vehicles that are ready for immediate action upon landing. Typically, in an emergency situation, external loads are dropped such that the VTOL aircraft can then safely perform an autorotation landing. Of course, such a procedure is not applicable to a manned external load.

Accordingly, it is desirable to provide a method for landing a VTOL aircraft with an external load.

### SUMMARY OF THE INVENTION

The VTOL aircraft landing method according to the present invention provides for winching down an external load under the force of gravity such that the external load lands prior to the VTOL aircraft. As the external load reaches a predetermined distance, cables attached to the external load are braked to hang the external load below the VTOL aircraft.

In an autorotation situation, the VTOL aircraft is essentially performing a flair at an altitude which is equivalent to the predetermined distance such that the external load achieves a relatively soft landing. Upon external load touchdown, the VTOL aircraft descent will greatly slow as the external load is no longer supported by the VTOL aircraft. Once the external load has landed, the VTOL aircraft is displaced relative the external load such that the VTOL aircraft lands adjacent the external load while still connected thereto by the cables. The cables may alternatively or additionally be released from the VTOL aircraft.

The landing method of the present invention is also applicable to a rapid vehicle deployment in which the VTOL aircraft need not land.

The present invention therefore provides a method for landing a VTOL aircraft with an external load.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general side view of an exemplary VTOL aircraft embodiment with an external load for use with the present invention;

FIG. 2 is a landing sequence for a VTOL aircraft and external load according to the present invention;

FIG. 3 is a graphical representation of an external load release;

FIG. 4 is a graphical representation of a brake force for the released external load; and

FIG. 5 is an autorotative index for various VTOL aircraft.

### DETAILED DESCRIPTION OF THE PREFERRED EMBODIMENT

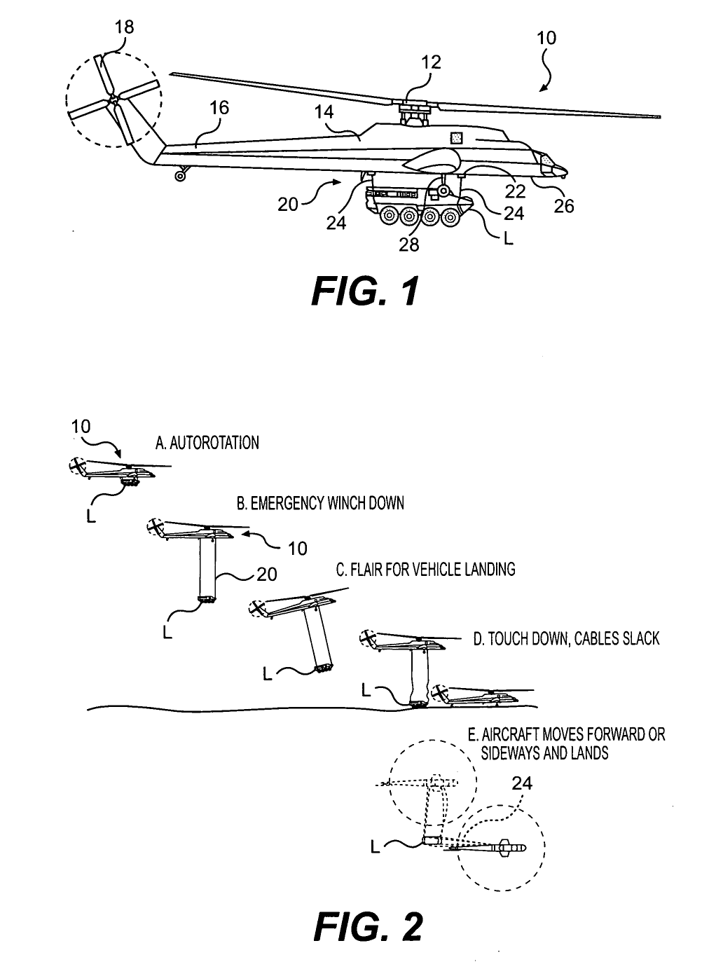

FIG. 1 schematically illustrates a VTOL aircraft 10 having a main rotor assembly 12. The aircraft 10 includes an airframe 14 having an extending tail 16 which mounts an anti-torque rotor 18. Although a particular flying crane type helicopter configuration which does not include a cabin section is illustrated in the disclosed embodiment, other VTOL machines such as tilt-rotor and tilt-wing aircraft will also benefit from the present invention.

An external load L, such as a manned vehicle, is attached to the airframe 14 through a four-point sling system 20. The sling system 20 preferably includes four hoists 22 which deploy a cable 24 to each corner of the external load L for attachment thereof. The cables 24 are connected to the external load L in any conventional manner. The four-point sling system 20 preferably retracts the external load L to be carried close to an underside 26 of the airframe 14 and preferably maintains the external load L between the aircraft landing gear 28.

Referring to FIG. 2, a method of landing the VTOL aircraft 10 is illustrated. Initially, the VTOL aircraft 10 is traveling with the external load L attached to the VTOL aircraft 10 (position a). The VTOL aircraft 10 may then encounter an emergency condition, such as an engine failure, which requires an autorotation landing.

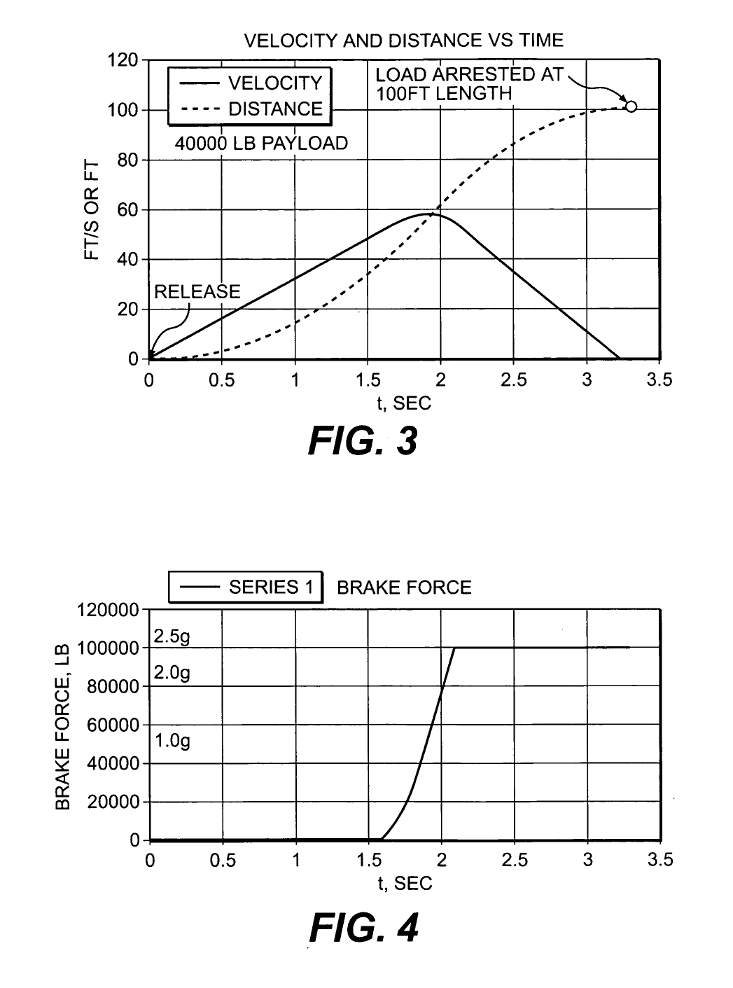

As the VTOL aircraft 10 begins a descent profile, the external load L is winched down preferably under the force of gravity (position b). The hoists 22 (FIG. 1) spool out the cables 24 to hang the external load L at a predetermined distance from the VTOL aircraft 10. Preferably, the predetermined distance is approximately one rotor diameter of the VTOL aircraft 10, however, other distances will likewise benefit from the present invention. As the external load L reaches the predetermined distance, the cables 24 are braked such as through a braking mechanism common to elevator systems. Applicant has determined that 100 feet of cable can be reeled out in less than four seconds with less than a 2.5 g load factor upon a 40,000 pound external load (FIGS. 3 and 4). Such a load factor is well within SHL VTOL aircraft design maneuvering requirements.

The VTOL aircraft 10 descent profile continues and is prepared to flair for landing (position c) until the external load L touches down (position d). In an autorotation situation, the VTOL aircraft 10 is essentially performing the flair at an altitude that is equivalent to the predetermined distance such that the external load L achieves a relatively soft landing. The landing descent rate may be specifically related to whether the external load is manned or unmanned such that additional margins of safety may be accrued to the VTOL aircraft when the external load is unmanned. That is, an unmanned external load may be subjected to a greater descent rate, which, although providing additional safety for the VTOL aircraft, still saves the external load.

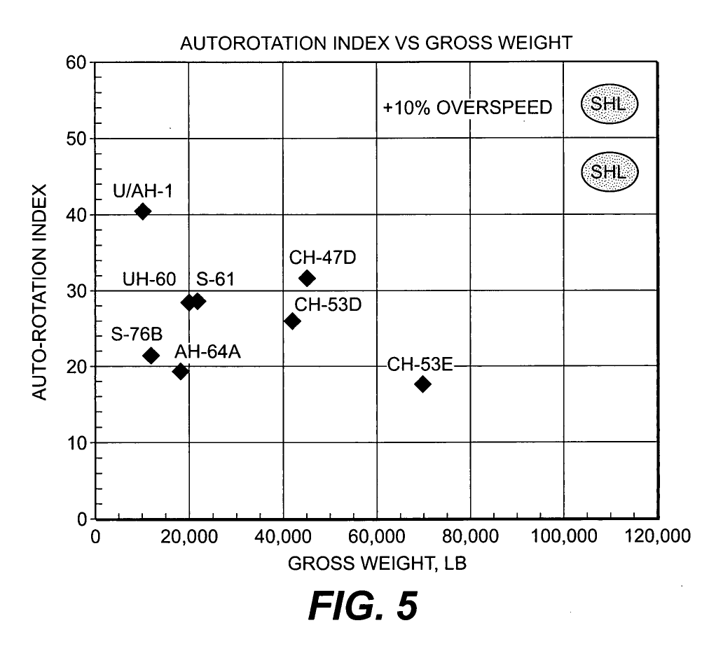

Upon external load L touchdown, the VTOL aircraft 10 descent will greatly slow as the external load L is no longer supported by the VTOL aircraft 10 and minimal requirements from the auto rotating rotor are required to finish autorotation as only the VTOL aircraft 10 itself is supported thereby. Two factors significantly affect autorotational performance, rotor rotational kinetic energy, and aircraft power required for flight. Rotational kinetic energy is a function of rotor inertia and rotational speed squared. Power required is primarily dictated by disk loading. The higher the kinetic energy and the lower the disk loading, the better the autorotational qualities. Due to the rotor capabilities relative the airframe size and weight, a SHL VTOL aircraft 10, such as a flying crane, provides exceeding good autorotative qualities (FIG. 5).

Once the external load L has landed, the VTOL aircraft 10 is displaced relative the external load L such that the VTOL aircraft can land adjacent the external load L while still connected thereto by cables 24 (position e). The cables 24 preferably provide a length equivalent to 1.5 times the rotor diameter to provide additional clearance for landing adjacent the external load L. The cables 24 may alternatively or additionally be released from the VTOL aircraft 10.

It should be understood that although the landing is described with reference to an autorotation, the landing method of the present invention is applicable to a rapid vehicle deployment in which the VTOL aircraft 10 is not in an autorotation situation and need not land. That is, the external load L is winched down, braked at the predetermined distance, and the aircraft flairs for landing such that only the external load L touches down (positions a-d). The cables may then be released and the VTOL aircraft 10 egresses rather than lands. Such a vehicle deployment is particularly useful in confined areas and/or where the vehicle need be deployed rapidly into action.

It should be understood that relative positional terms such as “forward,” “aft,” “upper,” “lower,” “above,” “below,” and the like are with reference to the normal operational attitude of the vehicle and should not be considered otherwise limiting.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A method of landing a VTOL aircraft with an external load comprising the steps of:
(1) displacing an external load from a VTOL aircraft a predetermined distance from the VTOL aircraft;
(2) landing the external load; and
(3) landing the VTOL aircraft.

2. A method as recited in claim 1, wherein said step (1) further comprises:
winching the external load to the predetermined distance.

3. A method as recited in claim 1, wherein said step (1) further comprises:
displacing the external load under the force of gravity.

4. A method as recited in claim 3, wherein said step (1) further comprises:
braking the external load to hang at the predetermined distance.

5. A method as recited in claim 1, wherein said step (1) further comprises:
displacing the external load to the predetermined distance of approximately one rotor diameter of the VTOL aircraft.

6. A method as recited in claim 1, further comprising the step of:
autorotating the VTOL aircraft to landing.

7. A method as recited in claim 1, further comprising the step of:
displacing the VTOL aircraft relative the external load after said step (2) and prior to said step (3).

8. A method of landing a VTOL aircraft with an external load comprising the steps of:
(1) initiating an autorotation of a VTOL aircraft;
(2) displacing an external load from the VTOL aircraft;
(3) braking the external load to hang a predetermined distance from the VTOL aircraft;
(4) landing the external load; and
(5) landing the VTOL aircraft.

9. A method as recited in claim 8, wherein said step (2) further comprises:
displacing the external load under the force of gravity.

10. A method as recited in claim 8, wherein said step (2) further comprises:
reeling out a four point sling system.

11. A method as recited in claim 8, further comprising the step of:
displacing the VTOL aircraft relative the external load after said step (4) and prior to said step (5).

12. A method as recited in claim 8, wherein said step (4) further comprises:
landing the external load while the external load is attached to the VTOL aircraft through a four point sling system.

13. A method as recited in claim 1, wherein said step (3) further comprises:
braking the external load to the predetermined distance of approximately one rotor diameter of the VTOL aircraft.

14. A method of landing a manned external load comprising the steps of:
(1) displacing a manned external load from a VTOL aircraft;
(2) braking the external load to hang a predetermined distance from the VTOL aircraft; and
(3) landing the external load.

15. A method as recited in claim 14, wherein said step (1) further comprises:
displacing the manned external load to the predetermined distance of approximately one rotor diameter of the VTOL aircraft.

16. A method as recited in claim 14, further comprising the step of:
landing the VTOL aircraft through an autorotation.
